(19) United States
(12) Patent Application Publication
(10) Pub. No.: US 2016/0243911 A1
(43) Pub. Date: Aug. 25, 2016

(54) METHOD FOR PRODUCING A SUSPENSION ARM AND MULTI-POINT SUSPENSION ARM FOR A MOTOR VEHICLE

(71) Applicant: ZF FRIEDRICHSHAFEN AG, Friedrichshafen (DE)

(72) Inventors: Jens WOHLERS, Lemfoerde (DE); Philipp BRONSWICK, Ostercappeln (DE); Michael MUEHL, Lengerich (DE)

(73) Assignee: ZF Friedrichshafen AG, Friedrichshafen (DE)

(21) Appl. No.: 15/031,790

(22) PCT Filed: Sep. 29, 2014
(86) PCT No.: PCT/EP2014/070721

§ 371 Date: Apr. 25, 2016

(30) Foreign Application Priority Data
Oct. 29, 2013 (DE) 102013221893.1

(51) Int. Cl. B60G 7/00

(52) U.S. Cl. CPC B60G 7/001; B60G 2206/122; B60G 2206/81; B60G 2204/148; B60G 2206/811; B60G 2206/82013

(57) ABSTRACT

A multi-point suspension arm for a chassis of a motor vehicle, which has two articulation points (A, B) on the vehicle side and an articulation point (C) on the wheel side for a supporting link (4). The multi-point suspension arm is made as a sheet-metal component. The wheel-side articulation point (C) has a defined angular position (a) relative to the vehicle-side articulation points (A, B). The suspension arm (1), in the area of the wheel-side articulation point (C), has a fixing surface for at least two different angular positions (C, C′) of the supporting link (4),

This application is a National Stage completion of PCT/EP2014/070721 filed Sep. 29, 2014, which claims priority from German patent application serial no. 10 2013 221 893.1 filed Oct. 29, 2013.

### FIELD OF THE INVENTION

The invention concerns a method for producing a suspension arm, and a multi-point suspension arm for the chassis of a motor vehicle.

### BACKGROUND OF THE INVENTION

Suspension arms are components of the chassis of a motor vehicle and serve for the suspension of the wheels on the body or axle of the motor vehicle. Longitudinal suspension arms and transverse suspension arms or two-point and three-point (multi-point) suspension arms are known.

DE 10 2004 039 175 A1 describes a transverse suspension arm for a wheel suspension, which is in the form of a profiled shaped-sheet component. The known transverse suspension arm has two lateral extensions approximately at right-angles to one another, with end areas to which connection elements are attached, which for example serve as a holder for a supporting link. As a rule the transverse suspension arm is in the form of a three-point arm, i.e. it is connected by means of two articulation points to the vehicle and by means of one articulation point to the wheel side, i.e. to a wheel carrier. When a vehicle is built in a variety of model variants and chassis, the problem can arise that the wheel-side articulation point is arranged in different positions and. for example, has to be displaced in the x-direction (travel direction) of the vehicle. In the known transverse suspension arm this problem is solved by attaching to the end area of one and the same transverse suspension arm different joint flanges, for example by riveting. Accordingly, for different link positions, in each case different joint flanges have to be provided.

### SUMMARY OF THE INVENTION

The purpose of the present invention is to propose a method for producing a suspension arm, which enables the suspension arm to be made economically with various link positions and which avoids the need for additional components. A further purpose of the invention is to propose a multi-point suspension arm for a chassis, which allows an articulation point to be located at different positions.

The objectives of the invention are achieved by virtue of the independent Claim. Advantageous design features of the invention emerge from the subordinate claims.

According to a first aspect of the invention, in a method for producing a suspension arm it is proposed that in a first process step an intermediate product of the suspension arm is first made by deformation, this intermediate product having an end area with a widened or lengthened fixing surface that allows a supporting link to be attached in various positions, i.e. in alternative positions arranged offset relative to one another. The invention is based on the thought of making an intermediate product first as a preliminary stage of the finished suspension arm, which is suitable for use with different link positions. Thus, the intermediate product allows at least two options for different link positions, which are preferably offset relative to one another in the travel direction or transversely thereto. Thus, a single pressing die can be used for the deformation in order to produce at least the intermediate product. In other words, for suspension arms of different vehicle types it is not necessary to have different forming dies in each case if each of the suspension arms only differs in its end area because of the location of the supporting link. In this way substantial cost savings can be achieved.

In a preferred embodiment of the invention, in a further, preferably second process step an opening for receiving the supporting link is made, the position of this receiving opening in the fixing surface corresponding to one of the possible alternative positions. The broadened fixing surface of the suspension arm enables the same suspension arm made as an intermediate product to be used for different link positions.

According to a further preferred embodiment, in a further, preferably third process step the final contour of the end area is made, in that the rim around the receiving opening in which the supporting link is arrange is trimmed, i.e. excess material is removed from the fixing surface. In particular the trimming is carried out so as to enable free clearance of the suspension arm relative to other chassis components, such as a brake disk.

In further preferred embodiments, both the formation of the receiving opening and also the trimming of the rim can be done by means of a laser beam. Laser cutting has the advantage that this process step can be carried out independently of and at a different time from the first process step of deformation. Thus, the receiving opening can be made only immediately before the fitting of the supporting link—in accordance with the desired link position. Alternatively, however, water-jet cutting, which gives burr-free machining, can be used.

In a further preferred embodiment the supporting link is inserted into the receiving opening and connected to the fixing surface, this connection preferably being made by laser welding. Alternatively the supporting link can also be press-fitted and/or also welded after being pressed in. The supporting link can also be fixed into the suspension arm with shape interlock by deformation after being inserted. In this way three different process steps, namely the formation of the receiving opening, the trimming of the rim and the connection of the supporting link to the end area can be carried out by means of laser technology or deformation, which simplifies the tooling required. The advantage of laser welding or laser beam cutting is that very little heat is input into the component, granted that a high heat input can result in undesired changes of the structure or material. Clearly, during water-jet cutting no undesired heat input can or does take place.

According to a further aspect of the invention, in the case of a multi-point suspension arm for the chassis of a motor vehicle it is provided that the fixing surface is wide or long enough for at least two alternative positions of the supporting link. This has the advantage that there is only one suspension arm type which, however, can be used for various link positions. Hence, there is a smaller number of different components for the chassis or vehicle. The multi-point suspension arm is preferably in the form of a shaped sheet-metal component. Alternatively, the suspension arm can also be made from a fiber-reinforced plastic such as organic sheet.

In a preferred embodiment, an opening for receiving the supporting link is formed within the fixing surface, such that the wheel-side articulation point is the mid-point of the opening and coincides with one of the at least two alternative positions. Thus, the receiving opening is positioned in the fixing surface in such manner that the articulation point or supporting link can adopt the desired angular position. This is done immediately before the fitting of the supporting link into the suspension arm.

In a further preferred embodiment the distance of the alternative positions for the articulation point can be in the range of a few centimeters apart, preferably 10 to 30 mm.

### BRIEF DESCRIPTION OF THE DRAWINGS

An example embodiment of the invention is illustrated in the drawings and is described in more detail below, so that further features and/or advantages can emerge from the description and/or the drawings. The drawings show:

FIG. 1: A transverse suspension arm according to the invention, with a supporting link position on the left,

FIG. 2: A transverse suspension arm with a supporting link position on the right,

FIG. 3: An end area of the transverse suspension arm, with a supporting link in position on the left,

FIG. 4: The end area of the transverse suspension arm, with a supporting link in position on the right,

FIG. 5: an intermediate product of the suspension arm, with its fixing surface,

FIG. 6: The fixing surface, but with the receiving opening in the left-hand position, and

FIG. 7: The fixing surface, with the receiving opening in the right-hand position.

### DETAILED DESCRIPTION OF THE PREFERRED EMBODIMENTS

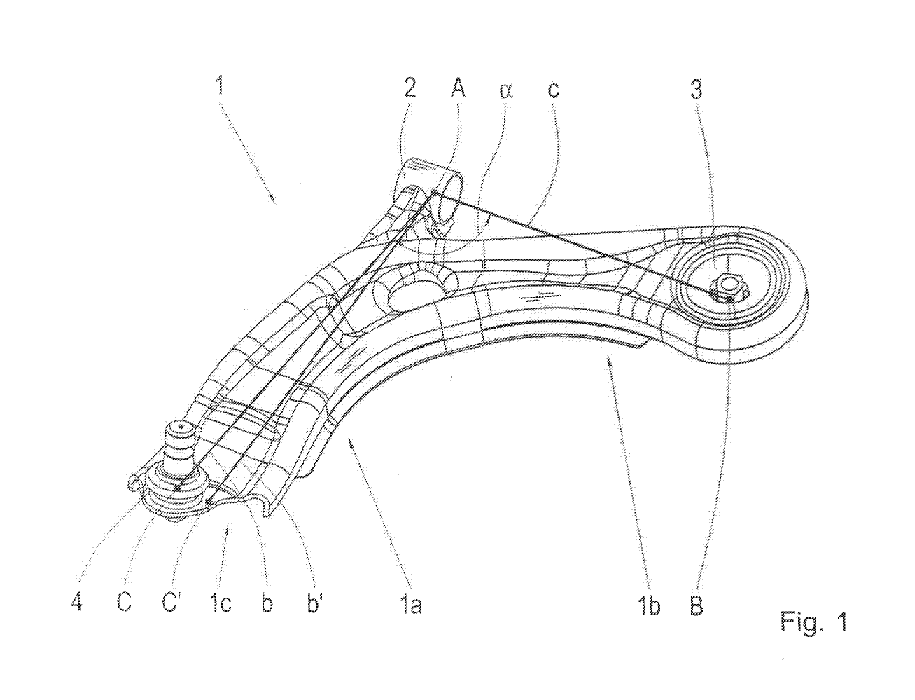

FIG. 1 shows a transverse suspension arm 1 in the form of a three-point arm, which is part of a chassis (not shown), in particular of a front axle of a motor vehicle. The transverse suspension arm 1 is in the form of a shaped sheet-metal component, having two extensions 1a, 1b arranged approximately perpendicularly to one another. The transverse suspension arm 1 has three articulation points, namely two articulation points A, B on the vehicle side, which are connected to one another by an axis c, and one articulation point C on the wheel side, which is connected to the articulation point A by a radius b. The joint in the area of the articulation point A is in the form of a swivel joint 2 with the swivel axis c, while the link in the area of the articulation point B is in the form of an elastic link 3 which also allows swiveling about the axis c, the latter being fixed relative to the vehicle. In the area of the articulation point C the extension 1a has an end area 1c, in which a supporting link 4 is fixed. The supporting link 4 is connected to a wheel carrier (not shown) and is therefore also called the wheel link 4. Thus, in the assembled condition the supporting link 4 can undergo a swiveling movement about the vehicle-side axis c, which extends approximately parallel to the vehicle axis x (travel direction). As can be seen from the drawing, the supporting link 4 is positioned asymmetrically relative to the longitudinal centerline of the section 1a, i.e. on the left side thereof, this being referred to as the left-hand position. The radius b forms with the axis an angle a, which is predetermined for a particular embodiment of the chassis. In differently designed chassis it can be necessary to displace the articulation point c so that it adopts the alternative position indicated by the articulation point C′. The alternative articulation point C′ is connected to the articulation point A on the vehicle side by a radius b′. As explained in more detail below, it is within the scope of the invention to arrange the supporting link 4 either in position C or in the displaced position C′, while using the same transverse suspension arm 1.

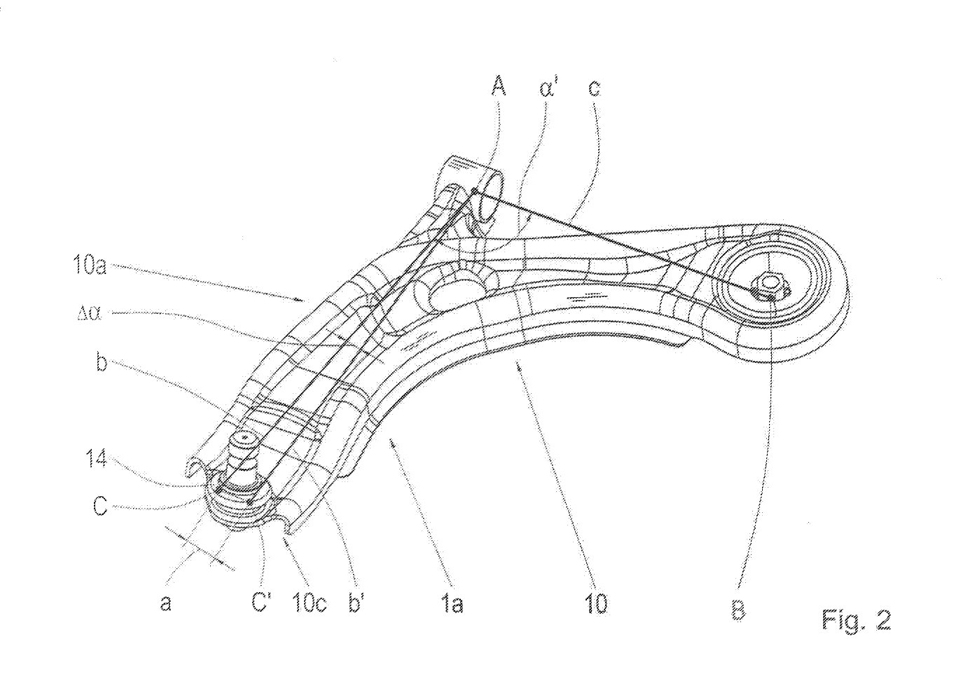

FIG. 2 shows a transverse suspension arm 10, in which—otherwise than in the example embodiment according to FIG. 1—the supporting link 14 is arranged in the area of the alternative articulation point C′, this being referred to as the right-hand position, i.e. also asymmetrical relative to the longitudinal centerline of the section 10a, The articulation point C′ is in an angular position corresponding to an angle α′ between the radius b′ and the axis c fixed relative to the vehicle. Thus, the example embodiments according to FIGS. 1 and 2 differ by having different angular positions, i.e. by a difference angle Δα between the radius b and the radius b′, due to a distance a between the positions C, C′. As mentioned earlier, both angular positions can be obtained using the same initial suspension arm (the so-termed intermediate product).

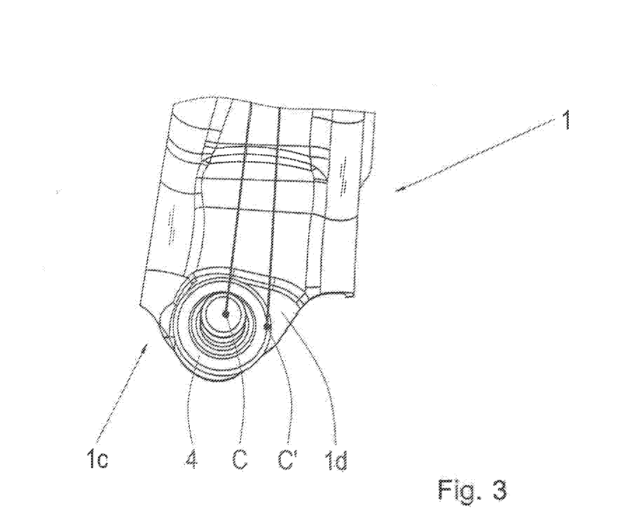

FIG. 3 shows an enlarged representation of the end area 1c (FIG. 1), as viewed from above, The supporting link 4 is in the area of the articulation point C, i.e, in the left-hand position. The end area 1c has an essentially flat fixing surface 1d, in the area of which the supporting link 4 is arranged and connected solidly to the transverse suspension arm 1.

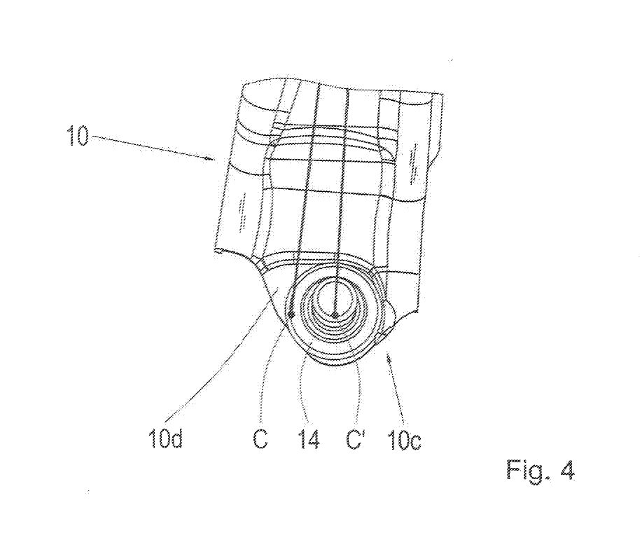

FIG. 4 shows an enlarged representation of the end area 1c of the transverse suspension arm 10 according to FIG. 2. In this case the supporting link 4 is in the area of the alternative articulation point C′, i.e. in the right-hand position. The other articulation point C is also in the area of the fixing surface 10d.

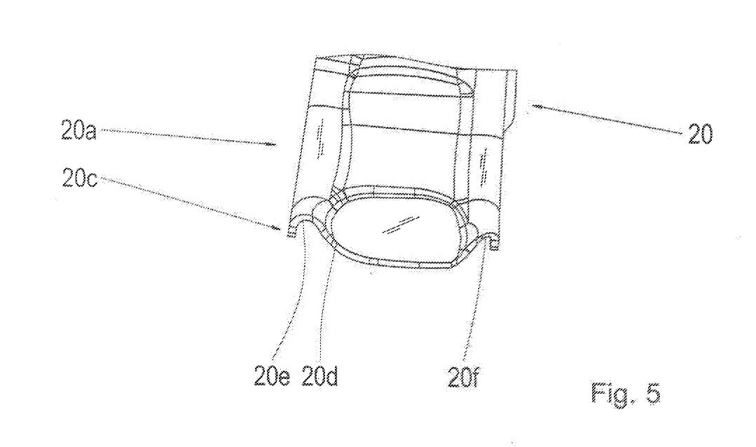

FIG. 5 shows a preliminary stage of a finished transverse suspension arm, i.e. an intermediate product during the production process. The transverse suspension arm 20 shown as an intermediate product has an end section 20c and an approximately oval and essentially flat fixing surface 20d, which for the sake of clarity is lightly shaded, The transverse suspension arm 20 is given this shape by deforming a sheet-metal panel in an appropriately shaped die, On each side the section 20a has a U-shaped stiffening profile 20e, 20f, which extend as far as the fixing surface 20d. The fixing surface 20d serves to enable the different positioning of the supporting link 4, 14, i.e. either in the left-hand position (as described above) or in the right-hand position, or even in another position located between these two extreme positions.

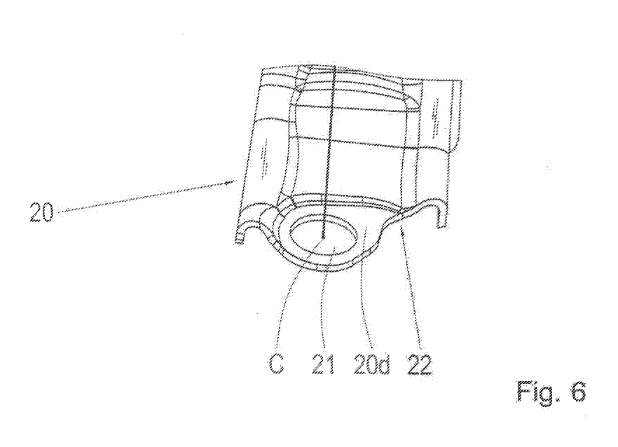

FIG. 6 shows the transverse suspension arm 20 with a circular opening 21 in its fixing surface 20d. The mid-point of the circular opening 21 is the articulation point C, i.e. the left-hand position. The rim of the fixing surface 20d, as it appears in FIG. 5, is trimmed in the area to the right next to the opening 21 so that a trimmed edge contour 22 is obtained. Thanks to this trimming a free space is provided for adjacent parts of the transverse support arm, for example a brake disk. The opening 21 serves to receive the supporting link 4 shown in FIGS. 1 to 3. The cutting out of the circular opening 21 is preferably done by means of a laser beam, as also is the trimming of the edge. The supporting element is preferably fixed to the transverse suspension arm 20 or to its fixing surface 20d by laser beam welding. Thus, these work steps can be carried out immediately before or during the fitting of the transverse suspension arm.

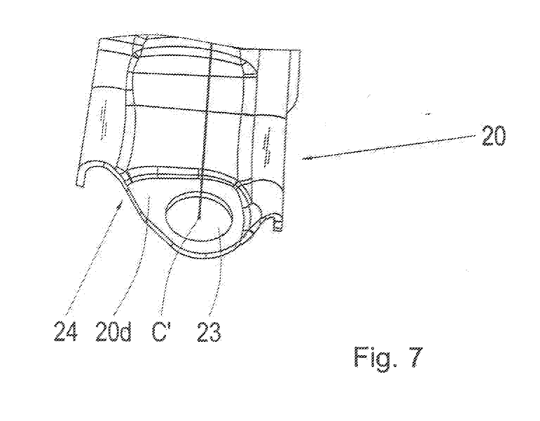

FIG. 7 shows a transverse suspension arm 20 with a circular receiving opening 23 in its fixing surface 20d, such that the mid-point of the opening 23 is the alternative articulation point C′. The fixing surface 20d of oval shape as in FIG. 5 is trimmed on the left of the opening 23 in FIG. 7, giving a trimmed edge contour 24. The opening 23 serves for positioning and fixing the supporting link 14 (FIGS. 2, 4) in the right-hand position.

The process for producing the transverse supporting arm or suspension arm takes place in a number of process steps, the first process step being the production of an intermediate product as shown in the form of the transverse support 20 in FIG. 5 with its oval fixing surface 20d. The dimensions of the fixing surface 20d are such that a supporting link can be arranged and fixed either in a left-hand or a right-hand position. The transverse support arm 20 shown in FIG. 5 is made by deforming a sheet panel and, by virtue of its profiled shape, has the requisite rigidity. In a second process step either the receiving opening 21 (FIG. 6) in the left-hand position or the receiving opening 23 (FIG. 7) in the right-hand position is made, preferably by laser beam cutting. At the same time or later, in a further process step the edge trimming takes place, again preferably by laser cutting. Thereafter, the supporting link 4 (FIG. 3) is inserted in the left-hand position or the supporting link 14 (FIG. 4) is inserted in the right-hand position. Finally, the supporting link 4 or 14 is fixed by laser welding. For that purpose the supporting link has a collar (not shown) which fits exactly when inserted into the receiving opening 21 or 23 and is connected to the fixing surface 20d by means of a laser-welded seam.

### INDEXES

1 Transverse suspension arm
1a Extension
1b Extension
1c End area
1d Fixing surface
2 Swivel bearing
3 Elastic link
4 Supporting link
10 Transverse suspension arm
10a Extension
10c End area
10d Fixing surface
14 Supporting link
20 Transverse suspension arm (intermediate product)
20a Extension
20c End area
20d Fixing surface
20e U-section 20f U-section
21 Opening
22 Edge contour
23 Opening
24 Edge contour
A Articulation point
Articulation point
C Articulation point
C′ Articulation point (alternative)
a Distance CC′
b Radius AC
b′ Radius AC′
c Axis AB
α Angle bc
α′ Angle b′c
Δα Angle difference

1-10. (canceled)

11. A method for producing a suspension arm (1, 10) which is in a form of a sheet-metal component and comprises an end area (1c, 10c) for fixing a supporting link (4, 14), the method comprising:
making an intermediate product (20) of the suspension arm (1, 10) by deformation, such that an end area (20c) of the intermediate product (20) has an essentially flat fixing surface (20d) for at least two alternative positions (C, C′) of the supporting link (4, 14); and
making an opening (21, 23) in the fixing surface (20d) for receiving the supporting link (4, 13) in one of the at least two alternative positions (C, C′), and then inserting the supporting link (4, 14) into the opening (21, 23) and connected to the fixing surface (20d).

12. The method according to claim 11, further comprising connecting the supporting link (4) to a wheel carrier.

13. The method according to claim 1 further comprising producing an edge contour (22, 24) of the end area (20c) by edge trimming either simultaneously with making the intermediate product (20) of the suspension arm or after making the intermediate product (20) of the suspension arm.

14. The method according to claim 11, further comprising making the opening (21, 23) either by laser cutting or by water-jet cutting.

15. The method according to claim 13, further comprising carrying out the edge trimming either by laser cutting or by water-jet cutting.

16. The method according to claim 11, further comprising forming the fixing surface (20d) to have an approximately oval shape.

17. The method according to claim 11, further comprising connecting the supporting link (4, 14) to the fixing surface (20d) either by laser welding or by deformation.

18. A method for producing a suspension arm (1, 10) from a sheet-metal component and having an end area (1c, 10c) for fixing a supporting link (4, 14) which is connectable to a wheel carrier, the method comprising:
forming an intermediate product (20) of the suspension arm (1, 10) to have an end area (20c) with a substantially flat fixing surface (20d) for at least two alternative positions (C, C′) of the supporting link (4, 14);
cutting an opening (21, 23) in the fixing surface (20d) in one of the at least two alternative positions for receiving the supporting link; and
inserting the supporting link (4, 14) into the opening (21, 23) and fixing the supporting link to the fixing surface (20d).

19. A method for producing a suspension arm (1, 10) which is in a form of a sheet-metal component and comprises an end area (1c, 10c) for fixing a supporting link (4, 14), the method comprising:
deforming sheet-metal to form an intermediate product (20) of the suspension arm (1, 10) so that an end area (20c) of the intermediate product (20) has an substantially flat fixing surface (20d) for at least two alternative positions (C, C′) of the supporting link (4, 14); and
forming an opening (21, 23) in the fixing surface (20d) for receiving the supporting link (4, 13) in one of the at least two alternative positions (C, C′); and
inserting the supporting link (4, 14) into the opening (21, 23).
